(19) United States
(12) Patent Application Publication
(10) Pub. No.: US 2008/0271902 A1
(43) Pub. Date: Nov. 6, 2008

(54) Fire prevention and extinguishing system and method of using same

(75) Inventors: Cary C. Johnson, League City, TX (US); Samuel Pipkin, Webster, TX (US)

Correspondence Address: ANDREWS & KURTH, L.L.P., 600 TRAVIS, SUITE 4200, HOUSTON, TX, 77002, US

(73) Assignee: CJS Concepts, LLC

(21) Appl. No.: 11/799,902

(22) Filed: May 3, 2007

(51) Int. Cl. A62C 3/06

(52) U.S. Cl. 169/56; 169/23

(57) ABSTRACT

A fire prevention and extinguishing system and method designed to prevent and automatically extinguish Christmas tree fires. The system preferably includes a case containing a fire extinguisher, controls, a ground fault circuit interrupter (“GFCI”) receptacle, a strobe light and a siren. A cable having heat sensors is connected to the case. The cable has a length sufficient to enable the heat sensors to be positioned throughout the Christmas tree. A hose is connected to the fire extinguisher and includes a portion which is positioned in the tree. The system is powered via 110 vac. Christmas light strings are plugged into the GFCI receptacle which automatically shuts off the power upon detection of an electrical short in the light strings, thereby preventing the occurrence of an electrical fire. Upon the occurrence of a tree fire, the heat sensors immediately detect the fire and activate the automatic fire extinguishing portion of the system. Upon activation, the fire extinguisher discharges its contents via the positioned hose and extinguishes the fire, electrical power to the GFCI receptacle is automatically shut off, the strobe light is turned on, and the siren sounds a loud warning. Within seconds, the occupants are warned and the tree fire is extinguished.

### CROSS-REFERENCE TO RELATED APPLICATIONS

Not applicable.

### BACKGROUND OF THE INVENTION

1. Field of the Invention

The present invention relates generally to fire prevention and fire extinguishing systems, and more particularly to fire prevention and fire extinguishing systems and methods for holiday tree fires, such as Christmas tree fires.

2. Description of the Related Art

The holiday season, which includes Christmas and New Year's Day, is typically regarded as extending from late November to early January. During the holiday season, many individuals and families, particularly of the Christian faith, choose to celebrate the season by decorating their homes and/or work places with candles, wreaths and Christmas trees decorated with ornaments and electric lights. Although artificial trees are used by some, a great many people still prefer to decorate a cut “live” or natural tree. This has been a custom for centuries and will most certainly continue indefinitely.

Although for approximately one-third of American households, the holiday season would not be complete without a beautifully decorated natural Christmas tree, the fact is that the natural Christmas tree becomes more of a fire hazard as the holiday season progresses. Every year, newspapers report tragic stories of families killed by fires started by ignited Christmas trees. As the holiday season progresses, the trees become drier and the incidence of Christmas tree fires worsens. For example, the U.S. Fire Administration reported in 2001 that for the period of 1996-1998, there were an average of 1.2 Christmas tree fires per day during December 1-14, whereas the average increased to 7.7 Christmas tree fires/day during December 15 to January 1. The U.S. Fire Administration also reported that Christmas trees annually account for 200 fires, resulting in six deaths, 25 injuries and more than $6,000,000 in property damage.

Over the course of the holiday season, the Christmas tree, originally freshly cut or “wet,” dries out over time. Particularly in areas of cold winter weather, the heat in residences is turned up, removing humidity from air, which dries the Christmas tree even more.

A dry Christmas tree is like a bomb in one's home. For example, the Building and Fire Research Laboratory of the National Institute of Standards and Technology has demonstrated that within three seconds of igniting a dry Scotch pine, it is completely ablaze, and, at five seconds, the fire extends up the tree and black smoke with searing gases streaks across the ceiling. The fire is fed by fresh air near the floor and nearby furniture and carpet may ignite prior to any flame contact. “Flashover” occurs within 40 seconds resulting in the entire room erupting into flames, depletion of oxygen, and dense, deadly toxic smoke engulfing the scene.

Typically, tree fires are started by faulty wiring or shorts in electrical lights, lit candles, gas-fueled equipment such as pilot lights and gas fireplaces, lighters or matches. Tree fires have also been attributed to children seeking to light holiday candles in the proximity of the Christmas tree or placing a lit candle too close to the tree. It is foreseeable that a tree fire could be started from a errant spark flying several feet from the fireplace. It is also foreseeable that a small child or the family pet knocks the Christmas tree over bringing the tree into contact with a lit candle or fireplace.

It is desirable to eliminate the risks of bodily harm and property damage resulting from having a Christmas tree in the home during the holiday season, particularly a live tree. It is desirable to prevent a Christmas tree from catching fire due to faulty wiring or shorts in electrical lights. It is further desirable to quickly and automatically extinguish a Christmas tree fire regardless of how it is initiated.

### SUMMARY OF THE INVENTION

The preferred embodiment of the present invention is a fire prevention and fire extinguishing system and method for holiday tree fires, such as Christmas tree fires. The system is designed to prevent and automatically extinguish Christmas tree fires.

The system preferably includes a case containing a fire extinguisher, controls, a ground fault circuit interrupter (“GFCI”) receptacle, a strobe light and a siren. The system also preferably includes a cable, connected to the case, having a cable portion including one or more beat sensors. Preferably, the cable portion has a length sufficient to enable the cable and heat sensors to be positioned throughout the Christmas tree. The heat sensors are preferably snap disc heat sensors.

The preferred embodiment of the system includes a hose connected to the fire extinguisher with a portion of the hose positioned in the Christmas tree. The system also includes an electrical cable for plugging into a typical wall outlet providing 110 volt alternating current (“vac”) and powering the system.

Typically, Christmas trees are decorated with strings of electrical lights. Preferably, the strings of lights and any other electric tree decorations are plugged into the system's GFCI receptacles. The GFCI receptacles of the preferred system automatically shut off the power to the light strings and other electrical devices upon detection of an electrical short occurring within the plugged in devices, thereby preventing the occurrence of an electrical fire.

However, tree fires may occur due to events other than electrical shorts. Irrespective of the cause, upon the occurrence of a tree fire, the fire is immediately detected by one or more of the system's heat sensors positioned within the tree according to the present invention. Upon detection of excessive heat, the heat sensor activates the automatic fire extinguishing portion of the system. Upon activation, the fire extinguisher discharges its extinguishing agent via the positioned hose and extinguishes the fire. Preferably, electrical power to the GFCI receptacles is automatically shut off, the strobe light is turned on, and the siren sounds a loud warning. Thus, within seconds the tree fire is automatically extinguished and the occupants are warned of the fire, thereby saving lives and/or minimizing property damage.

In the preferred embodiment of the invention, the automatic fire extinguishing portion of the system remains activated even if the GFCI receptacles have been tripped, as for example, due to an electrical short or current overload, or when the power to the GFCI receptacles has been switched off via a switch.

### BRIEF DESCRIPTION OF THE DRAWINGS

A better understanding of the present invention can be obtained when the following detailed description of a preferred embodiment is considered in conjunction with the drawings in which:

FIG. 1 is a diagrammatic view of an embodiment of the fire prevention and fire extinguishing system in use in conjunction with a Christmas tree;

FIG. 2 is a top and front perspective view of an enclosed case according to a preferred embodiment of the present invention;

FIG. 3 is rear elevation view of the enclosed case of FIG. 2, and showing power cord, heat detector cable and fire extinguishing hose connectors;

FIG. 4 is a plan view of the case top and-case bottom in an open position, the wiring of the electrical components being omitted for clarity;

FIG. 5 is a schematic diagram of a preferred embodiment of the system components within the case, the schematic diagram showing the system in an operating standby mode; and

FIGS. 5A and 5B are separate schematic diagrams of the AC circuit and the DC circuit, respectively, of FIG. 5, showing the system in the operating standby mode.

### DETAILED DESCRIPTION OF THE PREFERRED EMBODIMENT

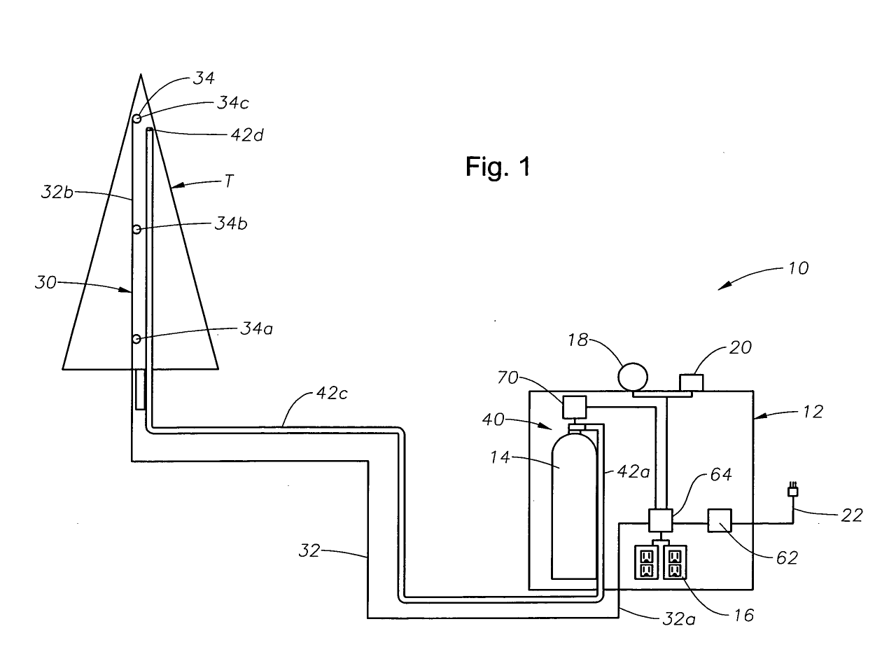

The fire prevention and fire extinguishing system according to a preferred embodiment of the present invention is generally referenced in the drawings as number 10. The preferred embodiment of the present invention is a system and method designed to prevent and automatically extinguish holiday tree fires, such as Christmas tree fires. FIG. 1 is a diagrammatic view of an embodiment of the fire prevention and fire extinguishing system 10 in use in conjunction with a Christmas tree T.

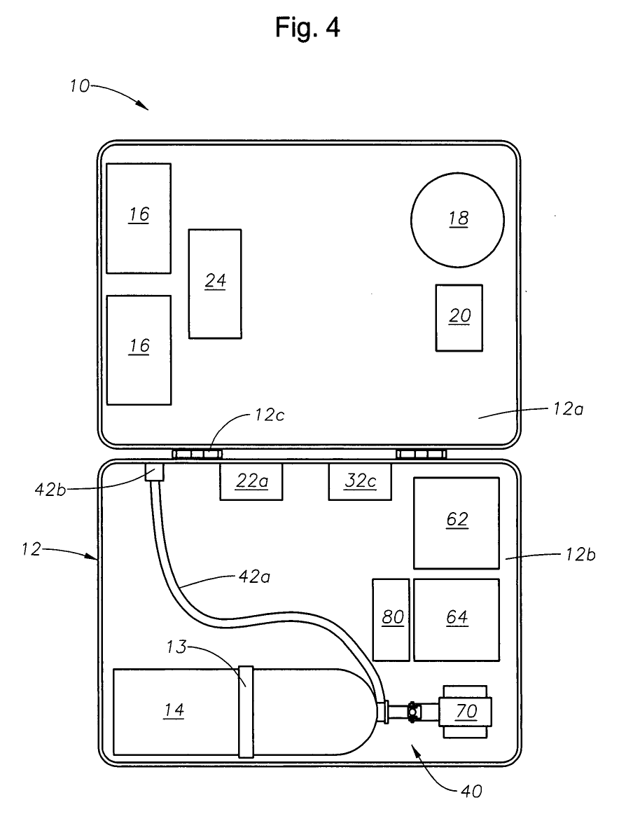

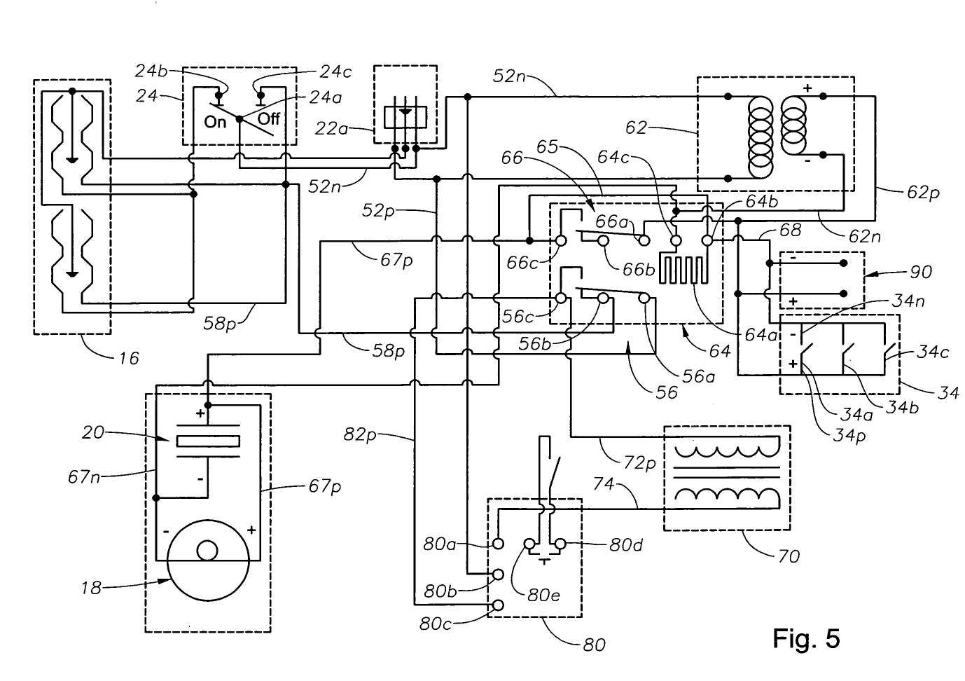

With reference to FIGS. 1, 2 and 4, the system 10 according to a preferred embodiment includes a case 12 containing a fire extinguisher 14 (FIGS. 1 and 4), one or more receptacles 16, preferably ground fault circuit interrupter (“GFCI”) receptacles, a strobe light 18 and a siren 20. Referring to FIG. 1, a power cord 22 adapted to plug into a wall outlet, typically a 110 vac outlet, preferably provides electrical power to the system 10. The power cord 22 may be permanently attached to the case 12 or detachably connected to the case 12 via a power connector 22a as shown in FIG. 3. Preferably, the power connector 22a is accessible exteriorly of the enclosed case 12.

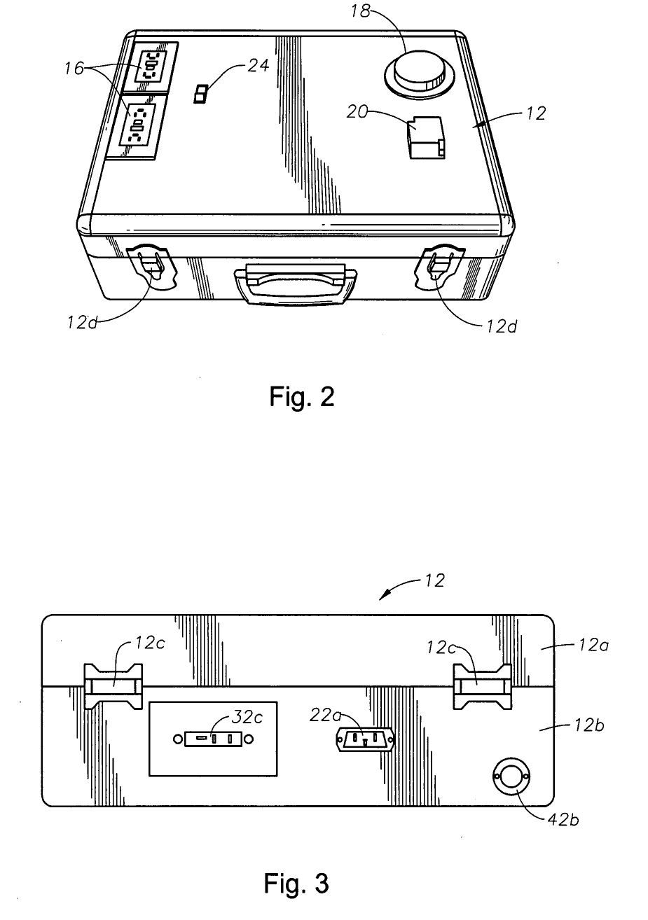

Referring to FIG. 3, the case 12 preferably has a top portion 12a hingedly connected 12c to a bottom portion 12b with one or more latch assemblies 12d to form an enclosed case when latched (FIG. 2) and permitting access to the interior of the case 12 in an open position when unlatched as shown in FIG. 4. Although not shown, the case 12 preferably includes a locking mechanism to restrict access to the interior of the case 12. This is desirable to prevent unauthorized persons or children from tampering with the components housed inside the case 12.

Referring to FIGS. 2 and 4, the receptacles 16 are preferably flush-mounted to the case 12 and accessible exteriorly of the enclosed case 12. Preferably, the strobe light 18 is mounted to the case 12 such that the strobe light 18 is adapted to emit a light exterior of the enclosed case 12. The siren 20 is preferably mounted to the case 12 and is adapted to project an audible alarm exterior of the enclosed case 12 for reasons which will be explained below.

Still referring to FIG. 2, a receptacle power switch 24 is also preferably mounted to the case 12 and accessible exteriorly of the enclosed case 12. The switch 24 allows 110 vac electrical power to the GFCI receptacles 16 to be switched on and off for reasons which will be explained below. In the preferred embodiment of the invention, the switch 24 only controls the power to the GFCI receptacles 16.

Referring to FIG. 1, the system 10 also includes a heat detecting assembly 30. Preferably, the heat detecting assembly 30 comprises a cable 32 having a first end 32a connected to the case 12 and a second cable portion 32b including a heat sensor 34, preferably a plurality of spatially-separated heat sensors 34a-c. It is to be understood that the desired number of heat sensors 34 may vary. For example, it may be desirable to include 5 or more heat sensors. Also, it is to be understood that the cable 32 includes wires (not shown) for direct wiring of the heat sensors 34 to the case 12 as described below. The cable 32 preferably includes a protective sheath to ensure that the cable wires communicate the signal from the heat sensor(s) 34 to the controls in the case 12 in the event of a fire or excessive heat. Alternatively, it is to be understood that infra-red heat sensors may be positioned in the tree T to remotely communicate with the controls in the case 12, in which instance the communication cable 32 is not required.

The second cable portion 32b has a length sufficient to enable the heat sensor 34 to be positioned within the Christmas tree T, and more preferably has a length sufficient to enable a plurality of heat sensors 34a-c to be spatially-separated within the Christmas tree T, and more preferably spaced along the height of the tree T. In the preferred embodiment of the present invention, the second cable portion 32b is installed along the trunk of the tree T and terminates in the upper portion of the tree T. The cable first end 32a may be permanently attached to the case 12 or detachably connected to the case 12 via a cable connector 32c as shown in FIG. 3. Preferably, the cable connector 32c is accessible exteriorly of the enclosed case 12.

The heat sensors 34 are preferably snap disc or mechanical spring-loaded heat sensors. Preferably, the beat sensors 34 have a temperature rating of approximately 110° F., although temperature rated heat sensors ranging from 110-160° F. may be used.

Referring again to FIG. 1, the fire extinguisher 14 is part of a fire extinguishing assembly 40 of the system 10 according to the preferred embodiment of the present invention. With reference to FIG. 4, the fire extinguishing assembly 40 preferably includes a first hose 42a within the case 12 connected at one end to the fire extinguisher 14 and at a second end to a hose outlet 42b mounted to the case 12. With reference to FIG. 1, a second hose 42c releasably connects to the hose outlet 42b (FIG. 3) at one end and is adapted to discharge the extinguishing agent of the fire extinguisher 14 at a second end 42d. Preferably, the discharge end 42d is positioned near the upper portion of the tree T and includes a type of spray head or nozzle for spraying the fire extinguishing agent throughout the tree T and preferably above the tree. It is to be understood that one of skill in the art would know of several types of suitable spray heads or nozzles suitable for this purpose.

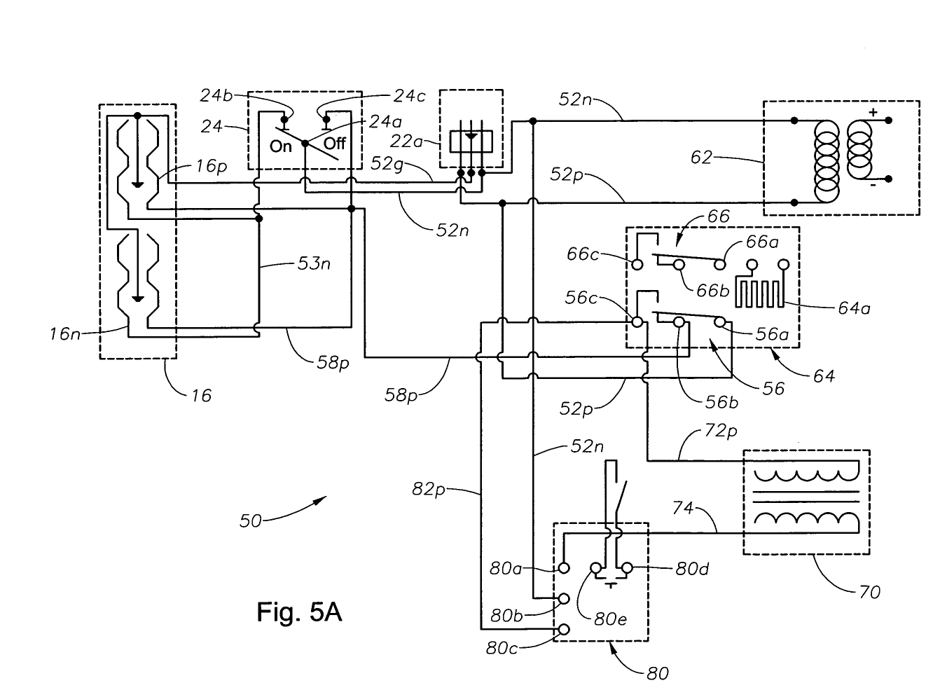

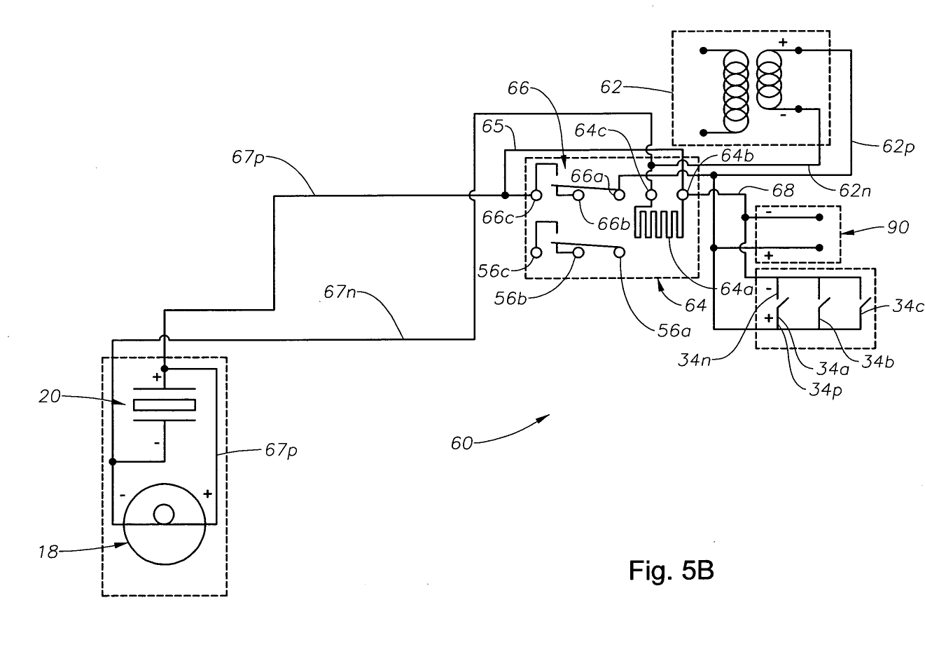

A more detailed discussion of the electrical control portion of the system 10 will now be described with reference to FIGS. 5, 5A and 5B. FIGS. 5A and. 5B are separate schematic diagrams of the AC and DC circuits, 50 and 60 respectively, of FIG. 5, showing the system 10 in the operating standby mode.

Referring to FIGS. 5 and 5A, the power cord 22 (FIG. 1) delivers 110 vac from a wall outlet (not shown) to the fire prevention and extinguishing system 10 via the power connector 22a. The AC circuit 50 includes a switch 24 for controlling power (110 vac) to the receptacles 16, preferably GFCI receptacles. In the preferred embodiment of the invention, the switch 24 only controls the power to the GFCI receptacles 16. Preferably, the Christmas tree light strings and other electrical devices (not shown) are plugged into the receptacles 16. The switch 24 can thus be used to turn all the tree lights and other devices on and off. The GFCI receptacles 16 of the preferred system 10 automatically “trip” and shut off the power to the light strings and other electrical devices upon detection of an electrical short occurring within the plugged in devices, thereby preventing the occurrence of an electrical fire.

The AC circuit 50 also powers a transformer 62 having a direct current output, preferably an output of 12 volts direct current (“vdc”). It is to be understood that alternatively the transformer output could be another voltage, as for example, 24 vdc. Referring now to FIG. 5B, the transformer 62 powers the DC circuit 60 and includes positive and negative leads 62p and 62n, respectively. In the preferred embodiment of the system 10 as shown in FIG. 5B, the transformer positive lead 62p is connected to pin 66a of a first relay 66 of a relay module 64 and also connected to a positive lead 34p of each heat sensor 34 via the cable 32 (FIG. 1). A second heat sensor lead 34n is connected to lead 68 which is connected to a first terminal 64b of a relay actuator 64a. A second terminal 64c of the relay actuator 64a is connected to the transformer negative lead 62n. Preferably, the relay actuator 64a is a coil.

Still referring to FIG. 5B, the first relay 66 also includes pins 66b and 66c. A positive lead 67p connects first relay pin 66c to the strobe light 18 and siren 20 and a second lead 67n returns from the light 18 and siren 20 to the transformer negative lead 62n.

FIG. 5B shows the DC circuit 60 in a normal or operating standby mode. Upon any of the heat sensors 34a-c sensing too much heat, the heat sensor closes to complete the circuit resulting in actuation of the relay actuator 64a. Actuation of the relay actuator 64a causes the first relay 66 to change from state 66a-66b (as shown in FIG. 5B) to state 66a-66c which closes the DC circuit 60 and activates the strobe light 18 and siren 20.

Referring again to FIG. 5A, the transformer 62 is powered by live wire 52p and neutral wire 52n. The relay module 64 includes a second relay 56 which is connected to the AC circuit 50. The live wire 52p is connected to pin 56a of the second relay 56. The second relay 56 also includes pins 56b and 56c. Conductor 58p connects second relay pin 56b to the positive terminals 16p of the receptacles 16 and to switch terminal 24c of the receptacle switch 24. Neutral wire 52n is connected to switch terminal 24a of the receptacle switch 24. A conductor 53n connects switch terminal 24b to the negative terminals 16n of the receptacles 16. The receptacles 16 are grounded with a ground wire 52g.

In the preferred embodiment of the invention, first relay pin 56c is connected to a solenoid 70 and a timer module 80 via conductors 72p and 82p, respectively. Neutral wire 52n is also connected to the timer module 80 and the timer module 80 is further connected to the solenoid 70 as shown in FIG. 5A.

In the operating standby mode as shown in FIG. 5A, the second relay 56 assumes its normal state 56a-56b to provide 110 vac to the receptacles 16 when the switch 24 is in the on position. When the switch 24 is in the off position and the second relay 56 is in its normal state 56a-56b, power is not provided to the receptacles 16.

As stated above and with reference to FIG. 5B, upon any of the heat sensors 34a-c sensing too much heat, the heat sensor 34 closes to complete the DC circuit 60 resulting in actuation of the relay actuator 64a. Actuation of the relay actuator 64a causes not only the first relay 66 to change state but also causes the second relay 56 to change from state 56a-56b (as shown in FIG. 5A) to state 56a-56c.

With reference to FIG. 5A, as the second relay 56 changes to state 56a-56c, the portion of the AC circuit 50 controlling the fire extinguishing assembly 40 (FIG. 4) of the system 10 is closed. Upon the second relay 56 changing to state 56a-56c, the solenoid 70 is electrically activated to mechanically actuate the fire extinguisher 14 (FIG. 1), thereby discharging the extinguishing agent from the fire extinguisher 14 through the hoses 42a-c and the discharge end 42d into, and preferably above, the Christmas tree T. The solenoid 70 is preferably mechanically coupled to the fire extinguisher 14, preferably the plunger rod of the fire extinguisher 14. Upon the extinguishing agent being fully discharged, the timer module 80 preferably deactivates the solenoid 70 and/or disconnects the power to the solenoid 70. Preferably, the extinguishing agent is fully discharged within approximately fifteen (15) seconds of the heat sensor 34 being activated. Preferably, the fire extinguisher 14 has a discharge time of approximately 8-12 seconds, or less. The timer module 80 may have an adjustable “run” time of 15 to 60 seconds, or alternatively may have a set “run” time in the range of 15 to 60 seconds, more preferably in the range of 15 to 25 seconds. As used herein, the “run” time is the amount of elapsed time between the timer module 80 being activated by the second relay 56 to the timer deactivating the solenoid 70 and/or disconnecting the power to the solenoid 70.

Additionally, upon the second relay 56 changing to state 56a-56c, the power to the GFCI receptacles 16 is automatically cut off in the preferred embodiment of the present invention.

In the operating standby mode of the preferred embodiment of the invention as depicted in FIGS. 5, 5A and 5B, the automatic fire extinguishing portion of the system remains activated even if the GFCI receptacles 16 have been tripped, as for example, due to an electrical short or current overload where no fire resulted.

Preferably, the system 10 remains “armed” in the standby mode even if the power switch 24 is in the off position and the tree lights are off. Thus, the system 10 continues to provide protection in the event the Christmas tree is ignited by a spark from a nearby fireplace, a candle, a space heater or any other device capable of starting the tree on fire. Additionally, the system 10 remains armed and operable in the event the Christmas tree accidentally tips over and catches on fire.

The control system of the preferred embodiment of the present invention can be incorporated in the self-contained case 12 placed near or at the base of the Christmas tree T. Preferably, the case 12 is a fire resistant box and small enough to be placed under or adjacent the Christmas tree T. For example, the control system can fit within a case 12 measuring approximately 13″×18″×6″.

Preferably, the hose and heat detecting assembly 30 are placed up the center of the tree, preferably along a back side of the trunk, where the assembly 30 is less visible so as not to detract from the overall appearance of the Christmas tree T.

Preferably, the fire extinguisher 14 is a conventional dry chemical fire extinguisher having a valve head. Preferably, the fire extinguisher 14 includes a pressure indicator or pressure gauge to ensure that the fire extinguisher 14 is operable. As shown in FIG. 1, the case 12 preferably includes a strap 13 for releasably securing the fire extinguisher 14 to the case 12.

Typically, a fire extinguisher 14 includes a tamper seal (not shown) which must be broken in order to use the fire extinguisher. In the preferred embodiment of the present invention, the solenoid 70 is mechanically coupled to the fire extinguisher 14 without breaking the tamper seal. Thus, the tamper seal remains intact and unbroken until such time that the solenoid 70 actuates the fire extinguisher to discharge the extinguishing agent. In the preferred embodiment of the present invention, the response time from heat sensor activation to initial discharge of fire extinguisher is approximately three (3) seconds or less.

A dry chemical fire extinguisher 14 is preferred as its contents can be easily swept up without causing damage to the contents in the room. The fire extinguisher 14 could also use a CO₂ extinguishing agent. Preferably, the fire extinguisher is a non-exploding type to facilitate easy clean up. Preferably, the fire extinguishing agent maintains a sufficient atmospheric condition to support life for a predetermined time interval so that occupants can evacuate from the area safely and without injury. Therefore, should small children be in the area when a fire occurs the fire extinguishing system 10 will automatically extinguish the fire without harming the children.

It is to be understood that although the preferred system 10 has been described as an analog system, the system could alternatively be a digital system.

It is also within the scope of the present invention to include a module 90 adapted to communicate with a home alarm system in the event of a fire. Such communication could be wireless. For example, upon activation of the fire extinguisher or the heat sensor a signal could be transmitted from the module 90 to the home alarm system, which in turn could notify the fire or police departments, for immediate assistance.

The fire prevention and extinguishing system 10 according to a preferred embodiment of the present invention provides multiple lines of defense and protection.

The heat sensors 34 positioned within the tree T immediately detect the occurrence of a tree fire. The heat sensors 34 activate the automatic fire extinguishing portion 40 of the system 10. Upon activation, the fire extinguisher 14 discharges its contents via the positioned hose 42 and extinguishes the fire. Preferably, electrical power to the GFCI receptacles 16 is automatically shut off, the strobe light 18 is turned on, and the siren 20 sounds a loud warning. Thus, within seconds the tree fire is automatically extinguished and the occupants are warned of the fire, both audibly and visually, thereby saving lives and/or minimizing property damage. The siren 20 provides an audible warning to people in and around the home, while the strobe light 18 provides a visible warning to people within sight of the room. Preferably, the warnings alert everyone in and around the home, whether or not in the immediate room, even if asleep, or disabled, such as blind or deaf.

The tree-positioned heat sensors additionally detect excessive heat, i.e., heat exceeding the rating of the heat sensors. Thus, if the heat sensors are rated at 120° F., and the temperature exceeds 120° F., the fire extinguisher 14, siren 20 and strobe light 18 are activated and the power to the GFCI receptacles 16 is cut off, irrespective of an actual fire or detection of smoke. Such measures taken by the system 10 will most probably eliminate the dangerous situation prior to a fire occurring.

Additionally, protection with respect to electrical shorts or current overloads is provided by plugging the electric tree decorations and lights in the GFCI receptacles 16. Upon such an event, the GFCI receptacles 16 will trip and the dangerous situation will be alleviated, with the tripped GFCI receptacles providing an indication that an electrical problem exists or may exist requiring attention.

Furthermore, the system 10 provides protection even when the GFCI receptacles have tripped or when the receptacle power switch 24 has been turned off, as for example upon going to sleep at night. The automatic fire extinguishing portion of the system 10 including the heat sensors 34, siren 20 and strobe light 18 remains activated as long as the system is connected to 100 vac.

The preferred embodiment of the present invention functions independently of fire or smoke and provides precautionary safeguards against a tree fire occurring while further providing measures to control and extinguish a tree fire in the event one occurs.

The foregoing disclosure and description of the invention are illustrative and explanatory thereof, and various changes in the size, shape and materials, as well as the details of the illustrated operation and construction may be made without departing from the spirit and scope of the invention.

We claim:

1. A fire prevention and extinguishing system for use with a tree having electrical decorations, comprising:
a portable case comprising:
a fire extinguisher having fire extinguishing contents; and
an actuating circuit for actuating said fire extinguisher;
a hose assembly coupled to said fire extinguisher and having a hose portion positioned within the tree;
a heat detecting assembly comprising at least one heat sensor positioned within the tree and coupled to said actuating circuit,
wherein upon sensing a predetermined temperature said at least one heat sensor is activated to close said actuating circuit and actuate said fire extinguisher so that said fire extinguishing contents are discharged through said hose assembly within the tree.

2. The system of claim 1, wherein said at least one heat sensor is coupled to a cable connected to said actuating circuit.

3. The system of claim 1, wherein said at least one heat sensor comprises a plurality of heat sensors spatially positioned within the tree.

4. The system of claim 3, wherein said plurality of heat sensors are coupled to a cable connected to said actuating circuit.

5. The system of claim 1, wherein said at least one heat sensor is a snap disc heat sensor.

6. The system of claim 1, further comprising a power source for powering said actuating circuit.

7. The system of claim 6, wherein said power source comprises electrical power supplied from a 110 volt alternating current supply source.

8. The system of claim 1, further comprising an audible device designed and arranged to be activated by said at least one heat detecting assembly.

9. The system of claim 8, wherein said audible device is a siren.

10. The system of claim 1, further comprising a light source designed and arranged to be activated by said at least one beat detecting assembly.

11. The system of claim 10, wherein said light source is a strobe light.

12. The system of claim 1, further comprising:
a ground fault circuit interrupter receptacle coupled to said portable case; and
a switch coupled to said portable case for controlling the delivery of power to said ground fault circuit interrupter receptacle.

13. The system of claim 1, wherein said actuating circuit comprises a solenoid mechanically coupled to said fire extinguisher.

14. The system of claim 13, wherein said actuating circuit includes a timer module arranged and designed to deactivate said solenoid following activation of said solenoid.

15. The system of claim 13, further comprising:
an occupant warning device coupled to said actuating circuit;
wherein said actuating circuit further comprises a relay module having a relay actuator and first and second relays, said relay actuator arranged and designed to change the state of said first and second relays, said first relay coupled to said occupant warning device and said second relay coupled to said solenoid

16. A method for extinguishing a tree fire comprising the steps of:
positioning a heat detecting assembly within the tree;
coupling a hose to a fire extinguisher;
providing a control assembly for actuating the fire extinguisher;
providing communication between the heat detecting assembly and the control assembly;
wherein upon the heat detecting assembly detecting excessive heat, the heat detecting assembly communicates with the control assembly to actuate the fire extinguisher which dispenses an extinguishing agent via the hose throughout the tree.

17. The method of claim 16, further comprising the step of positioning a portion of the hose within the tree.

18. The method of claim 16, wherein said step of providing a control assembly for actuating the fire extinguisher comprises activating a solenoid to mechanically actuate the fire extinguisher.

19. The method of claim 18, further comprising the step of deactivating the solenoid following activation of the solenoid.

20. A method for preventing and extinguishing a tree fire comprising the steps of:
positioning a heat detecting assembly within the tree;
coupling a hose to a fire extinguisher;
providing an occupant warning device;
providing a control assembly for actuating the fire extinguisher and the occupant warning device;
providing communication between the heat detecting assembly and the control assembly;
wherein upon the heat detecting assembly detecting excessive heat, the heat detecting assembly communicates with the control assembly to actuate the fire extinguisher which dispenses an extinguishing agent via the hose throughout the tree, and also communicates with the control assembly to actuate the occupant warning device.

21. The method of claim 20, further comprising the step of positioning a portion of the hose within the tree.

22. The method of claim 20, wherein said step of providing a control assembly for actuating the fire extinguisher comprises activating a solenoid to mechanically actuate the fire extinguisher.

23. The method of claim 22, further comprising the step of deactivating the solenoid following activation of the solenoid.

24. The method of claim 22, wherein said step of providing an occupant warning device comprises providing a strobe light.

25. The method of claim 22, wherein said step of providing an occupant warning device comprises providing a siren.

26. The method of claim 22, wherein said step of providing a control assembly further comprises providing a relay module having a relay actuator and first and second relays, the relay actuator arranged and designed to change the state of the first and second relays, the first relay coupled to the occupant warning device and the second relay coupled to the solenoid.

27. The method of claim 26, further comprising the step of providing a ground fault interrupter receptacle coupled to the second relay.

28. A fire safety system for use with a Christmas tree having electrical decorations, comprising:
a fire extinguisher having fire extinguishing contents;
an occupant warning device;
an actuating assembly for actuating said fire extinguisher and said occupant warning device;
a hose assembly coupled to said fire extinguisher;
a heat detecting assembly comprising at least one heat sensor positioned within the tree and coupled to said actuating assembly,
wherein upon sensing a predetermined temperature said at least one heat sensor communicates a signal to said actuating assembly to actuate said occupant warning device and to actuate said fire extinguisher so that said fire extinguishing contents are discharged through said hose assembly within the tree.

29. The fire safety system of claim 28, further comprising
a ground fault circuit interrupter receptacle coupled to said actuating assembly; and
a switch coupled to said ground fault circuit interrupter receptacle for controlling the delivery of power to said ground fault circuit interrupter receptacle.

30. The fire safety system of claim 29, wherein said actuating assembly comprises:
a solenoid mechanically coupled to said fire extinguisher; and
a relay module having a relay actuator and first and second relays, said relay actuator arranged and designed to change the state of said first and second relays, said first relay coupled to said occupant warning device and said second relay coupled to said solenoid and said ground fault circuit interrupter receptacle.
